(19) United States
(12) Patent Application Publication
(10) Pub. No.: US 2017/0150014 A1
(43) Pub. Date: May 25, 2017

(54) METHOD AND ELECTRONIC DEVICE FOR VIDEO DENOISING AND DETAIL ENHANCEMENT

(71) Applicants: LE HOLDINGS (BEIJING) CO., LTD., Beijing (CN); LECLOUD COMPUTING CO., LTD., Beijing (CN)

(72) Inventors: Yang LIU, Beijing (CN); Maosheng BAI, Beijing (CN); Wei WEI, Beijing (US); Yangang CAI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/246,374

(22) Filed: Aug. 24, 2016

Related U.S. Application Data
(63) Continuation-in-part of application No. PCT/CN2016/083054, filed on May 23, 2016.

(30) Foreign Application Priority Data
Nov. 24, 2015 (CN) 201510828893.3

(51) Int. Cl. H04N 5/217

(52) U.S. Cl. CPC H04N 5/217

(57) ABSTRACT

The embodiments of the present invention provide a method and a device video denoising and detail enhancement. The method includes: acquiring the pixel value of a current pixel in a frame as a first pixel value, and acquiring the pixel values of adjacent pixels in the up, down, left and right sides of the current pixel; denoising the current pixel to acquire the second pixel value of the current pixel; determining whether the current pixel is a detail pixel; and if the current pixel is determined as the detail pixel, calculating the detail pixel value of the current pixel according to the first pixel value and the second pixel value, and using the detail pixel value to update the first pixel value. The present invention implements effective denoising, and reserves and enhances the image details of a video frame in the meanwhile.

### CROSS REFERENCE TO RELATED APPLICATIONS

This application is a continuation-in-part of International Application No. PCT/CN2016/083054, filed on May 23, 2016, which claims priority to Chinese Patent Application No. 201510828893.3, filed on Nov. 24, 2015, the entire contents of which are incorporated herein by reference.

### TECHNICAL FIELD

The embodiments of the present invention relate to the field of video technologies, and, more particularly, to a method and a device for video denoising and detail enhancement.

### BACKGROUND

With the rapid development of digital video applications, various noises are inevitably introduced during the process of video collection, transmission, coding and decoding in a digital video system, while the existence of noises not only severely affects the subjective visual quality of the videos, but also affects the subsequent processing of the videos, for example, coding, transcoding, or the like. Therefore, with the wide application of the digital videos, an effective video denoising method is urgently needed.

The video denoising methods may substantially include such types as time-domain denoising, spatial-domain denoising, time-domain and spatial-domain denoising. Although noises in a frame may be removed through the video denoising, details of the frame will be lost meanwhile, so that the denoised frame becomes blurry.

Therefore, it is highly desirable to propose a method for video denoising and detail enhancement.

### SUMMARY

The embodiments of the present invention provide a method and a device for video denoising and detail enhancement, for solving the defect in the prior art that the user needs to manually press keys to switch video output modes and implementing the automatic switching of the video output modes.

The embodiment of the present invention provides a method for video denoising and detail enhancement, including:

acquiring the pixel value of a current pixel in a frame as a first pixel value, and acquiring the pixel values of adjacent pixels in the up, down, left and right sides of the current pixel;

denoising the current pixel to acquire the second pixel value of the current pixel according to the first pixel value and the pixel values of adjacent pixels in the up, down, left and right sides;

acquiring the pixel value of an N pixel in the same row with the current pixel and located behind the current pixel, acquiring the pixel value of an M pixel in the same column with the pixel and located below the pixel, and acquiring the pixel value of an (M,N) pixel in the same row with the M pixel and in the same column with the N pixel;

determining whether the current pixel is a detail pixel according to the first pixel value, the pixel value of the M pixel, the pixel value of the N pixel and the pixel value of the (M,N) pixel; and

if the current pixel is determined as the detail pixel, calculating the detail pixel value of the current pixel according to the first pixel value and the second pixel value, and using the detail pixel value to update the first pixel value.

The embodiment of the present invention provides an electronic device for video denoising and detail enhancement, including:

at least one processor; and

a memory communicably connected with the at least one processor for storing instructions executable by the at least one processor, wherein execution of the instructions by the at least one processor causes the at least one processor to:

acquire the pixel value of a current pixel in a frame as a first pixel value, and acquire the pixel values of adjacent pixels in the up, down, left and right sides of the current pixel;

denoise the current pixel to acquire the second pixel value of the current pixel according to the first pixel value and the pixel values of the adjacent pixels in the up, down, left and right sides;

acquire the pixel value of an N pixel in the same row with the current pixel and located behind the current pixel, acquire the pixel value of an M pixel in the same column with the pixel and located below the pixel, and acquire the pixel value of an (M,N) pixel in the same row with the M pixel and in the same column with the N pixel;

determine whether the current pixel is a detail pixel according to the first pixel value, the pixel value of the M pixel, the pixel value of the N pixel and the pixel value of the (M,N) pixel; and

if the current pixel is determined as the detail pixel, calculate the detail pixel value of the current pixel according to the first pixel value and the second pixel value, and use the detail pixel value to update the first pixel value.

The method and the device for video denoising and detail enhancement provided by the embodiments of the present invention implement effective denoising, and reserve and enhance the image details in a video frame through denoising each pixel and performing detail enhancement on the detail pixels in the video, so that the video quality is improved, and excellent viewing experience is brought to the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technical flow chart according to a first embodiment of the present invention;

FIG. 2 is a schematic diagram illustrating video denoising pixels according to the first embodiment of the present invention;

FIG. 3 is a schematic diagram illustrating detail enhancement pixels according to the first embodiment of the present invention;

FIG. 4 is a technical flow chart according to a second embodiment of the present invention;

FIG. 5 is a technical flow chart according to a third embodiment of the present invention;

FIG. 6 is a structural diagram illustrating a device according to a fourth embodiment of the present invention; and

FIG. 7 is a block diagram of an electronic device in accordance with some embodiments.

### DETAILED DESCRIPTION

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the present invention without going through creative efforts shall all fall within the protection scope of the present invention.

### First embodiment

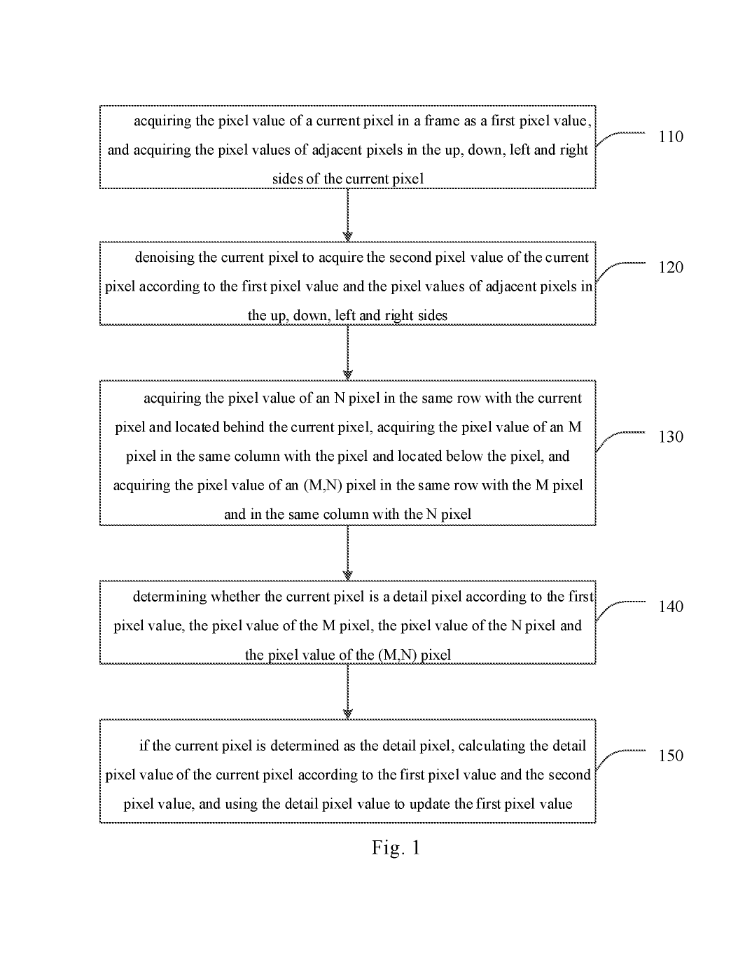

FIG. 1 is a technical flow chart according to the first embodiment of the present invention. With reference to FIG. 1, the embodiment of the present invention provides a method for video denoising and detail enhancement, mainly including the following steps.

In step 110: the pixel value of a current pixel in a frame is acquired as a first pixel value, and the pixel values of adjacent pixels in the up, down, left and right sides of the current pixel are acquired.

The denoising method employed in the embodiment of the present invention is based on a Gaussian denoising principle. Gaussian denoising is a linear smooth denoising manner, the denoising process of which is actually a process of performing weighted mean on each pixel in an image. During the Gaussian denoising process, the pixel value of each pixel is acquired by the pixel value thereof and other pixel values in adjacent domains after weighted mean. In the embodiment of the present invention, adjacent pixels in the up, down, left and right sides of a current pixel to be denoised are taken as the neighborhood pixels thereof.

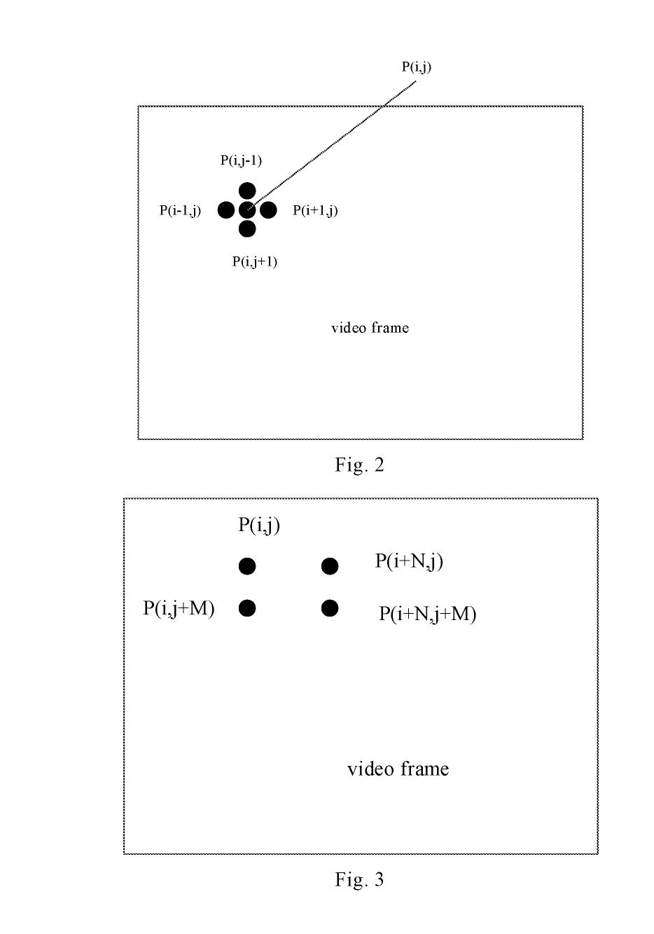

Therefore, during the denoising process of the embodiment of the present invention, the pixel value of a current pixel to be denoised and the pixel values of pixels in the neighborhood thereof are acquired firstly. As shown in FIG. 2, the pixel value of the current pixel is P(i,j), the pixel value of the adjacent pixel in the left side is P(i−1,j), the pixel value of the adjacent pixel in the right side is P(i+1,j), the pixel value of the adjacent pixel in the top side is P(i,j−1), and the pixel value of the adjacent pixel in the down side is P(i,j+1).

In step 120: the current pixel is denoised to acquire the second pixel value of the current pixel according to the first pixel value and the pixel values of adjacent pixels in the up, down, left and right sides.

To be specific, weighted average is performed to acquire the second pixel value according to the first pixel value, the preset denoising weight of the current pixel, the pixel values of the adjacent pixels in the up, down, left and right sides, and the denoising weights of the adjacent pixels in the up, down, left and right sides in this step.

In step 130: the pixel value of an N pixel in the same row with the current pixel and located behind the current pixel is acquired, the pixel value of an M pixel in the same column with the pixel and located below the pixel is acquired, and the pixel value of an (M,N) pixel in the same row with the M pixel and in the same column with the N pixel is acquired.

When all the pixels in the frame are completely denoised, detail enhancement is performed. During the detail enhancement process of the embodiment of the present invention, the pixel value of a neighborhood pixel in a certain side of the current pixel is utilized firstly to determine whether the current pixel is a pixel of detail part in the image. In the embodiment, the pixel values of a plurality of pixels in the right side and the down side of the current pixel are respectively taken as determination basis. As shown in FIG. 3, P(i,j) is the pixel value of the current pixel before denoising, P(i+N,j) is the pixel value of the N pixel, P(i,j+M) is the pixel value of the M pixel, and P(i+N,j+M) is the pixel of the (M,N) pixel.

In step 140: the current pixel is determined whether to be a detail pixel according to the first pixel value, the pixel value of the M pixel, the pixel value of the N pixel and the pixel value of the (M,N) pixel.

In the image, detail positions are corresponding to areas with larger pixel value fluctuation like profile and edge, rather than corresponding to areas with relatively flat pixel value fluctuation; therefore, the detail pixel may be determined through the pixel value fluctuation of the adjacent pixels of the current pixel.

In step 150: if the current pixel is determined as the detail pixel, then the detail pixel value of the current pixel is calculated according to the first pixel value and the second pixel value, and the detail pixel value is used to update the first pixel value.

Although the noises in the image are powerfully suppressed during the denoising process, the smoothing of the pixel values in the detail pixels are caused during the smoothing process of the image, thus resulting in image blurring. For each detail pixel, the first pixel value of the detail pixel before denoising represents a pixel value which is capable of showing the image details and added with certain noise pollution, while the second pixel value of the detail pixel after denoising represents the image details without noise pollution after being smoothed; therefore, a method of difference between the first pixel value and the second pixel value is adopted in the present invention to acquire the proximal pixel value of the detail pixel.

To be specific, a following formula is used to calculate the detail pixel value:

P″(i,j)=m*P(i,j)−n*P′(i,j) formula 1

In formula 1, P(i,j) is the first pixel value, P′(i,j) is the second pixel value, P″(i,j) is the detail pixel value, and multiplying factors in and n are integers.

It should be illustrated that the step 110 to the step 150 are traversely performed on each pixel in the video frame to be denoised until all the pixels are denoised and all the detail pixels are sought and enhanced completely.

In the embodiment, each pixel in the video frame is denoised, and the detail parts in the frame are sought and the pixels of the detail parts are enhanced for the deniosed video frame in the meanwhile, which implements effective denoising, and reserves and enhances the image details in the video frame in the meanwhile, so that the video quality is improved.

### Second Embodiment

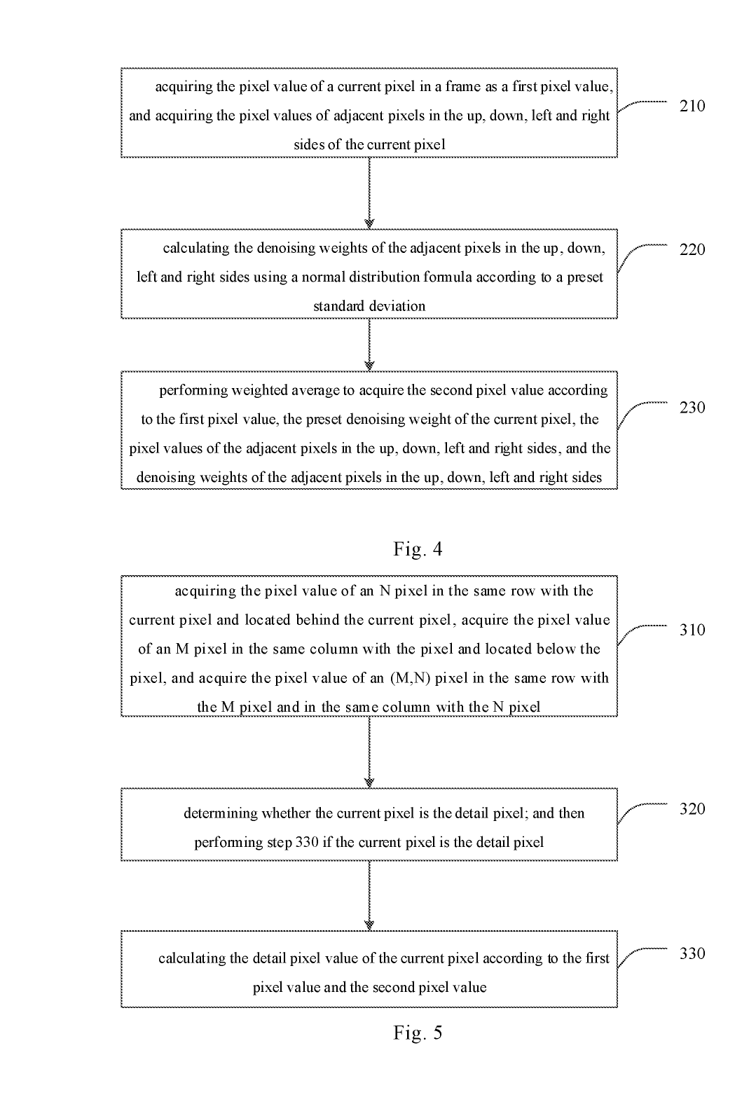

FIG. 4 is a technical flow chart according to the second embodiment of the present invention. With reference to FIG. 4, in the method for video denoising and detail enhancement provided by the embodiment of the present invention, the video denoising process is further implemented through the following steps.

In step 210: the pixel value of a current pixel in a frame is acquired as a first pixel value, and the pixel values of adjacent pixels in the up, down, left and right sides of the current pixel are acquired.

As shown in FIG. 2, the pixel value of the current pixel is (i,j), the pixel value of the adjacent pixel in the left side is P(i−1,j), the pixel value of the adjacent pixel in the right side is P(i′1,j), the pixel value of the adjacent pixel in the top side is P(i,j−1), and the pixel value of the adjacent pixel in the down side is P(i,j+1).

In step 220: the denoising weights of the adjacent pixels in the up, down, left and right sides are calculated using a normal distribution formula according to a preset standard deviation.

In the embodiment of the present invention, the denoising weights of the adjacent pixels in the up, down, left and right sides are calculated using a normal distribution formula, wherein the normal distribution formula is shown as follows:

$${f}_{x} = \frac{1}{σ \sqrt{2 π}} {e}^{\{ \frac{- {x}^{2}}{2 {σ}^{2}} \}} \qquad formula 2$$

In formula 2, is a normal distribution function, is a random variable, and is a normal distribution standard deviation.

In the embodiment of the present invention, the differences between the pixel value of the current pixel and the pixel values of the adjacent pixels in the up, down, left and right sides are used as the random variable x, and calculation is performed according to the present standard deviation. A specific calculation method is as shown in a following formula:

$${x}_{l} = [ P ( i - 1 , j ) - P ( i , j ) \\ {x}_{r} = P ( i + 1 , j ) - P ( i , j ) \\ {x}_{t} = P ( i , j - 1 ) - P ( i , j ) \\ {x}_{b} = P ( i , j + 1 ) - P ( i , j ) \\ {w}_{1} = \frac{1}{σ \sqrt{2 π}} {e}^{\{ \frac{- {x}_{1}^{2}}{2 {σ}^{2}} \}} = \frac{1}{σ \sqrt{2 π}} {e}^{\{ \frac{- {[ P ( i - 1 , j ) - P ( i , j ) ]}^{2}}{2 {σ}^{2}} \}} \\ {w}_{r} = \frac{1}{σ \sqrt{2 π}} {e}^{\{ \frac{- {x}_{r}^{2}}{2 {σ}^{2}} \}} = \frac{1}{σ \sqrt{2 π}} {e}^{\{ \frac{- {[ P ( i + 1 , j ) - P ( i , j ) ]}^{2}}{2 {σ}^{2}} \}} \\ {w}_{t} = \frac{1}{σ \sqrt{2 π}} {e}^{\{ \frac{- {x}_{t}^{2}}{2 {σ}^{2}} \}} = \frac{1}{σ \sqrt{2 π}} {e}^{\{ \frac{- {[ P ( i , j - 1 ) - P ( i , j ) ]}^{2}}{2 {σ}^{2}} \}} \\ {w}_{b} = \frac{1}{σ \sqrt{2 π}} {e}^{\{ \frac{- {x}_{b}^{2}}{2 {σ}^{2}} \}} = \frac{1}{σ \sqrt{2 π}} {e}^{\{ \frac{- {[ P ( i , j + 1 ) - P ( i , j ) ]}^{2}}{2 {σ}^{2}} \}} \qquad formula 3$$

In formula 3, xₗ, xᵣ, xₜ, x_{b} are the differences between the pixel value of the current pixel and the pixel values of the adjacent pixels in the up, down, left and right sides respectively, qₗ is the denoising weight of the adjacent pixel in the left side, wᵣ is the denoising weight of the adjacent pixel in the right side, wₜ is the denoising weight of the adjacent pixel in the top side, w_{b} is the denoising weight of the adjacent pixel in the down side, σ is a preset standard deviation, and σ=10 usually by experience.

In step 230: weighted average is performed to acquire the second pixel value according to the first pixel value, the preset denoising weight of the current pixel, the pixel values of the adjacent pixels in the up, down, left and right sides, and the denoising weights of the adjacent pixels in the up, down, left and right sides.

In the embodiment of the present invention, the denoising weight of the current pixel wₘ is a preset value, which is usually set according to the actual test experience and the noise intensity. The value of wₘ usually represents the denoising intensity; if the noise intensity of the current pixel is larger, then the value of wₘ shall be decreased properly, so that the influences of the noise pixels in the denoising result may be decreased; if the noise intensity of the current pixel is smaller, then the value of wₘ shall be increased properly, so that the smoothing effect of the pixels in the neighborhood on the current pixel denoised may be decreased. In the embodiment, the denoising weight of the current pixel wₘ=4.

A specific calculation formula for weighted average is as shown below:)

N(i,j)=[wₘ*P(i,j)+wₗ*P(i−1,j)+wᵣ*P(i+1,j)+wₜ*P(i,j−1)+w_{b}*P(i,j+1)]/(wₘ+wₗ+wᵣ+wₜ°w_{b}) formula 4

In formula 4, N(i,j) is the average value acquired through weighted average, i.e., the second pixel value.

Preferably, the embodiment of the present invention may detect the noise intensity of the current pixel so as to implement the adaptive change of wₘ according to the noise intensity, which is specifically implemented as follows.

In preferable step S1: the pixel value of the current pixel in a video frame to be denoised and the pixel value of a pixel at the same position of a previous adjacent frame are acquired respectively.

As shown in FIG. 2, the pixel value of the pixel in the current frame is P(i,j), the pixel value of the pixel at the same position of the previous adjacent frame is P′(i,j), wherein i,j are coordinates in the frame where the pixels locate and the acquiring in the step is traversely performed on all the pixels in the video frame.

In preferable step S2: the pixel value P(i,j) acquired is normalized, so that 0≦P≦1.

A specific formula for the normalization calculation is as follows:

$$V ( i , j ) = \frac{P ( i , j )}{255 - 0} \qquad formula 5$$

In formula 5, V(i,j) is a normalization calculation result, P(i,j) is the pixel value of each of the current pixel, 255 is the maximum pixel value, and 0 is the minimum pixel value.

In preferable step S3: a formula L(i,j)=(m*(1−|V′(i,j)−V(i,j)|))ⁿ*|V′(i,j)−V(i,j)| is used to calculate the noise intensity of the current pixel.

Wherein, V(i,j) is the pixel value of the current pixel after normalization, V′(i,j) is the pixel value of the pixel in the previous adjacent frame at the same position with the current pixel after normalization, and in and n are constants, both of which are empirical values and preset according to the denoising intensity. Upon test and research, the adaptive denoising result is optimal when the value of n ranges from 0.80 to 0.99.

In preferable step S4: the denoising weight of the current pixel is calculated according to a formula wₘ=x+y*L(i,j).

Wherein, x and y are empirical values and are regulated according to the noise intensity of the current pixel. When the noise intensity L(i,j) is greater than a specific threshold, the denoising weight of the current pixel is decreased by decreasing x and y, thus decreasing the denoising weight of the noise pixel to achieve preferable denoising effects.

Through performing the preferable steps S1 to S4, the preferable steps of the embodiment of the present invention may implement adaptive denoising according to the noise intensity changes.

It should be illustrated that all the steps of the third embodiment are traversely performed on each of the pixels in the video frame to be denoised to implement the denoising for all frames, and the specific repeating process will not be elaborated herein.

In the embodiment, the noises of the video frame are removed through smoothing each pixel in the video frame, so that the subjective visual quality of the video is improved, and the influence of the noises on the subsequent video processing is weakened. Meanwhile, the preferable steps in the embodiment implement the adaptive regulation of the denoising intensity, and can preferably reserve the details in the frame of a video with noise intensity changes or without noises.

### Third Embodiment

FIG. 5 is a technical flow chart according to the third embodiment of the present invention. With reference to FIG. 5, in the method for video denoising and detail enhancement provided by the embodiment of the present invention, the detail enhancement process is further implemented through the following steps.

In step 310: the pixel value of an N pixel in the same row with the current pixel and located behind the current pixel is acquired, the pixel value of an M pixel in the same column with the pixel and located below the pixel is acquired, and the pixel value of an (M,N) pixel in the same row with the M pixel and in the same column with the N pixel is acquired.

As shown in FIG. 3, P(i,j) is the pixel value of the current pixel before denoising, P(i+N,j) is the pixel value of the N pixel, P(i,j+M) is the pixel value of the M pixel, and P(i+N,j+M) is the pixel of the (M,N) pixel.

In step 320: the current pixel is determined whether to be the detail pixel; if the current pixel is the detail pixel, then step 330 is performed.

To be specific, the determination method is based on the first pixel value, the pixel value of the M pixel, the pixel value of the N pixel and the pixel value of the (M,N) pixel; if the first pixel value of the current pixel satisfies a following formula, then the current pixel is determined as the detail pixel:

$$\{ \begin{matrix}\vert P ( i , j ) - P ( i + N , j + M ) \vert > S \\ \vert P ( i + N , j ) - P ( i , j + M ) \vert > S\end{matrix} \qquad formula 6$$

In formula 6, P(i,j) is the first pixel value of the current pixel, P(i+N,j) is the pixel value of the N pixel, P(i,j+M) is the pixel value of the M pixel, P(i+N,j+M) is the pixel value of the (M,N) pixel, and S is a preset threshold.

In the embodiment, N=3, M=1 and S=10 are obtained according to a large number of experiment experience. The first pixel value of the current pixel is P(i,j), the N pixel is the third pixel in the same row of the current pixel and behind the current pixel, and the value thereof is P(i+3,j); the M pixel is the pixel in next row but same column of the current pixel, and the value thereof is P(i,j+1); and the (M,N) pixel is the pixel in next row of the current pixel and in the third column behind the current pixel, and the value thereof is P(i+3,j+1). N=3, M=1 and S=10 are substituted into formula 6:

$$\{ \begin{matrix}\vert P ( i , j ) - P ( i + 3 , j + 1 ) \vert > 10 \\ \vert P ( i + 3 , j ) - P ( i , j + 1 ) \vert > 10\end{matrix} \qquad formula {6}^{′}$$

If the values of the four pixels above satisfy the foregoing formula 6′, then the current pixel P(i,j) is recorded as the detail pixel.

In step 330: the detail pixel value of the current pixel is calculated according to the first pixel value and the second pixel value.

A following formula is used to calculate the detail pixel value:

P″(i,j)=m*P(i,j)−n*P′(i,j) formula 1

In formula 1, P(i,j) is the first pixel value, P′(i,j) is the second pixel value, P″(i,j) is the detail pixel value, and multiplying factors in and n are integers.

In the embodiment, m=2 and n=1 are obtained, and the formula 1 is P″(i,j)=2*P(i,j)−P′(i,j). The final detail pixel value of the pixel may be calculated by substituting the pixel value of the current pixel before denoising and the pixel value thereof after denoising, and the detail pixel value is used to update the first pixel value.

It should be illustrated that the step 310 to the step 320 are performed on each pixel after being denoised, so that blurry image details caused by ignoring partial detail pixels can be avoided.

In the embodiment, the pixel in the frame after being denoised is determined whether to be the detail pixel through the pixel values of the current pixel and the surrounding pixels thereof, the detail pixels are counted and subjected to detail enhancement, so that the image details are reserved and enhanced while implementing denoising, thus further optimizing the frame quality of the video and improving the viewing experience of the user.

### Fourth Embodiment

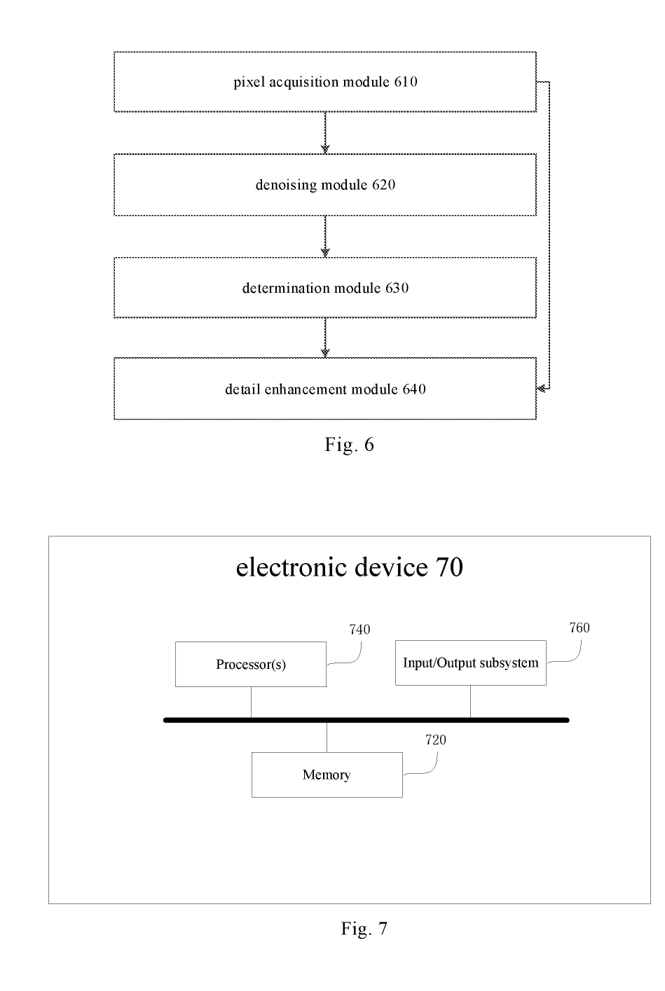

FIG. 6 is a structural diagram illustrating a device according to the fourth embodiment of the present invention. With reference to FIG. 6, the device for video denoising and detail enhancement according to the embodiment of the present invention mainly includes the following modules: a pixel acquisition module 610, a denoising module 620, a determination module 630 and a detail enhancement module 640.

The pixel acquisition module 610 is configured to acquire the pixel value of a current pixel in a frame as a first pixel value, and acquire the pixel values of adjacent pixels in the up, down, left and right sides of the current pixel; and is also configured to acquire the pixel value of an N pixel in the same row with the current pixel and located behind the current pixel, acquire the pixel value of an M pixel in the same column with the pixel and located below the pixel, and acquire the pixel value of an (M,N) pixel in the same row with the M pixel and in the same column with the N pixel;

the denoising module 620 is connected to the pixel acquisition module 610, and is configured to denoise the current pixel to acquire the second pixel value of the current pixel according to the first pixel value and the pixel values of the adjacent pixels in the up, down, left and right sides;

the determination module 630 is connected to the pixel acquisition module 610, and is configured to determine whether the current pixel is a detail pixel according to the first pixel value, the pixel value of the M pixel, the pixel value of the N pixel and the pixel value of the (M,N) pixel; and

the detail enhancement module 640 is connected to the denoising module 620 and the determination module 630, and is configured to, if the current pixel is determined as the detail pixel, calculate the detail pixel value of the current pixel according to the first pixel value and the second pixel value, and use the detail pixel value to update the first pixel value.

The denoising module 620 is further configured to perform weighted average to acquire the second pixel value according to the first pixel value, the preset denoising weight of the current pixel, the pixel values of the adjacent pixels in the up, down, left and right sides, and the denoising weights of the adjacent pixels in the up, down, left and right sides.

The denoising module 620 is further configured to calculate the denoising weights of the adjacent pixels in the up, down, left and right sides using a normal distribution formula according to a preset standard deviation.

The determination module 630 is further configured to, if the first pixel value of the current pixel satisfies a following formula, determine that the current pixel is the detail pixel:

$$\{ \begin{matrix}\vert P ( i , j ) - P ( i + N , j + M ) \vert > S \\ \vert P ( i + N , j ) - P ( i , j + M ) \vert > S\end{matrix}$$

wherein, P(i,j) is the first pixel value of the current pixel, P(i+N,j) is the pixel value of the N pixel, P(i,j+M) is the pixel value of the M pixel, P(i+N,j+M) is the pixel value of the (M,N) pixel, and S is a preset threshold.

The detail enhancement module 640 is further configured to use a following formula to calculate the detail pixel value:

P″(i,j)=m*P(i,j)−n*P′(i,j)

wherein, P(i,j) is the first pixel value, P′(i,j), is the second pixel value, P″(i,j) is the detail pixel value, and multiplying factors in and n are integers.

The device as shown in FIG. 6 may perform the methods of the embodiments as shown in FIG. 1, FIG. 4 and FIG. 5, and please refer to the embodiments as shown in FIG. 1, FIG. 4 and FIG. 5 for the implementing principles and technical effects which will not be elaborated.

Attention is now directed toward embodiments of an electronic device. FIG. 7 is a block diagram illustrating an electronic device 70. The electronic device may include memory 720 (which may include one or more computer readable storage mediums), at least one processor 740, and input/output subsystem 760. These components may communicate over one or more communication buses or signal lines. It should be appreciated that the electronic device 70 may have more or fewer components than shown, may combine two or more components, or may have a different configuration or arrangement of the components. The various components may be implemented in hardware, software, or a combination of both hardware and software.

The memory 720, as a non-volatile computer readable storage medium, may be configured to store non-volatile software programs, non-volatile computer executable programs and modules, for example, the program instructions/modules corresponding to the method for video denoising and detail enhancement in some embodiments of the present application. The non-volatile software programs, instructions and modules stored in the memory 720, when being executed, cause the processor 740 to perform various function applications and data processing, that is, performing the method for video denoising and detail enhancement in the above method embodiments.

The memory 720 may also include a program storage area and a data storage area. The program storage area may store an operating system and an application implementing at least one function. The data storage area may store data created according to use of the device for video denoising and detail enhancement. In addition, the memory 720 may include a high speed random access memory, or include a non-volatile memory, for example, at least one disk storage device, a flash memory device, or another non-volatile solid storage device. In some embodiments, the memory 720 optionally includes memories remotely configured relative to the at least one processor 740. These memories may be connected to the device for video denoising and detail enhancement over a network. The above examples include, but not limited to, the Internet, Intranet, local area network, mobile communication network and a combination thereof.

One or more modules are stored in the memory 720, and when being executed by the one or more processors 740, perform the method for video denoising and detail enhancement in any of the above method embodiments.

The product may perform the method according to some embodiments of the present application, has corresponding function modules for performing the method, and achieves the corresponding beneficial effects. For technical details that are not illustrated in detail in this embodiment, reference may be made to the description of the methods according to some embodiments of the present application.

Moreover, executable instructions for performing various functions may be included in a non-transitory computer readable storage medium or other computer program product configured for execution by at least one processor. Some embodiments of the present invention also provide a non-transitory computer-readable storage medium storing executable instructions that, when executed by an electronic device with a touch-sensitive display, cause the electronic device to perform the method as shown in FIG. 1, FIG. 4 or FIG. 5.

The electronic device in some embodiments of the present application is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone or the like;

(2) an ultra mobile personal computer device: which pertains to the category of personal computers and has the computing and processing functions, and additionally has the mobile Internet access feature; such terminals include: a PDA, an MID, an UMPC device or the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus or the like; the server is similar to the general computer in terms of architecture; however, since more reliable services need to be provided, higher requirements are imposed on the processing capability, stability, reliability, security, extensibility, manageability or the like of the device; and

(5) another electronic device having the data interaction function.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

It may be understood by those having ordinary skills in the art that the all or a part of steps of implementing the foregoing embodiments may be finished through relevant hardware instructed by a program. The program may be stored in a mobile device or a computer readable storage medium, and the program while performing includes the steps of the foregoing embodiments of the method. While the forementioned storage medium includes: various mediums that can store program codes such as ROM, RAM, magnetic disk or optical disk.

It should be finally noted that all the embodiments above are only configured to explain the technical solutions of the present invention, but are not intended to limit the protection scope of the present invention. Although the present invention has been illustrated in detail according to the foregoing embodiments, those having ordinary skills in the art should understand that modifications can still be made to the technical solutions recited in various embodiments described above, or equivalent substitutions can still be made to a part or whole of technical features thereof, and these modifications or substitutions will not make the essence of the corresponding technical solutions depart from the spirit and scope of the claims.

1. A method for video denoising and detail enhancement, comprising:
acquiring the pixel value of a current pixel in a frame as a first pixel value, and acquiring the pixel values of adjacent pixels in the up, down, left and right sides of the current pixel;
denoising the current pixel to acquire the second pixel value of the current pixel according to the first pixel value and the pixel values of the adjacent pixels in the up, down, left and right sides;
acquiring the pixel value of an N pixel in the same row with the current pixel and located behind the current pixel, acquiring the pixel value of an M pixel in the same column with the pixel and located below the pixel, and acquiring the pixel value of an (M,N) pixel in the same row with the M pixel and in the same column with the N pixel;
determining whether the current pixel is a detail pixel according to the first pixel value, the pixel value of the M pixel, the pixel value of the N pixel and the pixel value of the (M,N) pixel; and
if the current pixel is determined as the detail pixel, calculating the detail pixel value of the current pixel according to the first pixel value and the second pixel value, and using the detail pixel value to update the first pixel value.

2. The method according to claim 1, wherein acquiring the second pixel value of the current pixel further comprises:
performing weighted average to acquire the second pixel value according to the first pixel value, the preset denoising weight of the current pixel, the pixel values of the adjacent pixels in the up, down, left and right sides, and the denoising weights of the adjacent pixels in the up, down, left and right sides.

3. The method according to claim 2, further comprising:
calculating the denoising weights of the adjacent pixels in the up, down, left and right sides using a normal distribution formula according to a preset standard deviation.

4. The method according to claim 1, wherein determining whether the current pixel is the detail pixel further comprises:
if the first pixel value of the current pixel satisfies a following formula, determining that the current pixel is the detail pixel:
$$\{ \begin{matrix}\vert P ( i , j ) - P ( i + N , j + M ) \vert > S \\ \vert P ( i + N , j ) - P ( i , j + M ) \vert > S\end{matrix}$$
wherein, P(i,j) is the first pixel value of the current pixel, P(i+N,j) is the pixel value of the N pixel, P(i,j+M) is the pixel value of the M pixel, P(i+N,j+M) is the pixel value of the (M,N) pixel, and S is a preset threshold.

5. The method according to claim 1, wherein calculating the detail pixel value of the current pixel according to the first pixel value and the second pixel value further comprises:
using a following formula to calculate the detail pixel value:
P″(i,j)=m*P(i,j)−n*P′(i,j)
wherein, P(i,j) is the first pixel value, P′(i,j) is the second pixel value, P″(i,j) is the detail pixel value, and multiplying factors m and n are integers.

6. An electronic device for video denoising and detail enhancement, comprising:
at least one processor; and
a memory communicably connected with the at least one processor for storing instructions executable by the at least one processor, wherein execution of the instructions by the at least one processor causes the at least one processor to:
acquire the pixel value of a current pixel in a frame as a first pixel value, and acquire the pixel values of adjacent pixels in the up, down, left and right sides of the current pixel;
denoise the current pixel to acquire the second pixel value of the current pixel according to the first pixel value and the pixel values of the adjacent pixels in the up, down, left and right sides;
acquire the pixel value of an N pixel in the same row with the current pixel and located behind the current pixel, acquire the pixel value of an M pixel in the same column with the pixel and located below the pixel, and acquire the pixel value of an (M,N) pixel in the same row with the M pixel and in the same column with the N pixel;
determine whether the current pixel is a detail pixel according to the first pixel value, the pixel value of the M pixel, the pixel value of the N pixel and the pixel value of the (M,N) pixel; and
if the current pixel is determined as the detail pixel, calculate the detail pixel value of the current pixel according to the first pixel value and the second pixel value, and use the detail pixel value to update the first pixel value.

7. The electronic device according to claim 6, wherein the acquire the second pixel value of the current pixel further comprises:
perform weighted average to acquire the second pixel value according to the first pixel value, the preset denoising weight of the current pixel, the pixel values of the adjacent pixels in the up, down, left and right sides, and the denoising weights of the adjacent pixels in the up, down, left and right sides.

8. The electronic device according to claim 7, wherein the at least one processor is further caused to:
calculate the denoising weights of the adjacent pixels in the up, down, left and right sides using a normal distribution formula according to a preset standard deviation.

9. The electronic device according to claim 6, wherein the determine whether the current pixel is the detail pixel further comprises:
if the first pixel value of the current pixel satisfies a following formula, determine that the current pixel is the detail pixel:
$$\{ \begin{matrix}\vert P ( i , j ) - P ( i + N , j + M ) \vert > S \\ \vert P ( i + N , j ) - P ( i , j + M ) \vert > S\end{matrix}$$
wherein P(i,j) is the first pixel value of the current pixel, P(i+N,j) is the pixel value of the N pixel, P(i,j+M) is the pixel value of the M pixel, P(i+N,j+M) is the pixel value of the (M,N) pixel, and S is a preset threshold.

10. The electronic device according to claim 6, wherein the calculate the detail pixel value of the current pixel according to the first pixel value and the second pixel value further comprises:
use a following formula to calculate the detail pixel value:
P″(i,j)=m*P(i,j)−n*P′(i,j)
wherein, P(i,j) is the first pixel value, P′(i,j) is the second pixel value, P″(i,j) is the detail pixel value, and multiplying factors m and n are integers.

11. A non-transitory computer-readable storage medium storing executable instructions that, when executed by an electronic device with a touch-sensitive display, cause the electronic device to:
acquire the pixel value of a current pixel in a frame as a first pixel value, and acquire the pixel values of adjacent pixels in the up, down, left and right sides of the current pixel;
denoise the current pixel to acquire the second pixel value of the current pixel according to the first pixel value and the pixel values of the adjacent pixels in the up, down, left and right sides;
acquire the pixel value of an N pixel in the same row with the current pixel and located behind the current pixel, acquire the pixel value of an M pixel in the same column with the pixel and located below the pixel, and acquire the pixel value of an (M,N) pixel in the same row with the M pixel and in the same column with the N pixel;
determine whether the current pixel is a detail pixel according to the first pixel value, the pixel value of the M pixel, the pixel value of the N pixel and the pixel value of the (M,N) pixel; and
if the current pixel is determined as the detail pixel, calculate the detail pixel value of the current pixel according to the first pixel value and the second pixel value, and use the detail pixel value to update the first pixel value.

12. The non-transitory computer-readable storage medium according to claim 11, wherein the acquire the second pixel value of the current pixel further comprises:
perform weighted average to acquire the second pixel value according to the first pixel value, the preset denoising weight of the current pixel, the pixel values of the adjacent pixels in the up, down, left and right sides, and the denoising weights of the adjacent pixels in the up, down, left and right sides.

13. The non-transitory computer-readable storage medium according to claim 12, wherein the electronic device is further caused to:
calculate the denoising weights of the adjacent pixels in the up, down, left and right sides using a normal distribution formula according to a preset standard deviation.

14. The non-transitory computer-readable storage medium according to claim 11, wherein the determine whether the current pixel is the detail pixel further comprises:
if the first pixel value of the current pixel satisfies a following formula, determine that the current pixel is the detail pixel:
$$\{ \begin{matrix}\vert P ( i , j ) - P ( i + N , j + M ) \vert > S \\ \vert P ( i + N , j ) - P ( i , j + M ) \vert > S\end{matrix}$$
wherein, P(i,j) is the first pixel value of the current pixel, P(i+N,j) is the pixel value of the N pixel, P(i,j+M) is the pixel value of the M pixel, P(i+N,j+M) is the pixel value of the (M,N) pixel, and S is a preset threshold.

15. The non-transitory computer-readable storage medium according to claim 11, wherein the calculate the detail pixel value of the current pixel according to the first pixel value and the second pixel value further comprises:
use a following formula to calculate the detail pixel value:
P″(i,j)=m*P(i,j)−n*P′(i,j)
wherein, P(i,j) is the first pixel value, P′(i,j) is the second pixel value, P″(i,j) is the detail pixel value, and multiplying factors m and n are integers.
